(19) United States
(12) Patent Application Publication
(10) Pub. No.: US 2005/0193563 A1
(43) Pub. Date: Sep. 8, 2005

(54) Auxiliary part for an electric shaver

(76) Inventors: Jasper Zuidervaart, Drachten (NL); Albert Jan Aitink, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 11/120,586

(22) Filed: May 3, 2005

Related U.S. Application Data
(63) Continuation of application No. 10/024,769, filed on Dec. 20, 2001.

(30) Foreign Application Priority Data
Dec. 22, 2000 (EP) 00204809.8

(51) Int. Cl. B26B 19/06

(52) U.S. Cl. 30/34.2

(57) ABSTRACT

The present invention relates to an auxiliary part (7) for mounting and removing accessories such as a skin-stretcher (9), a lubricator (14), etc. on and from the outer cutting member (4) of an electric shaver.

In order to provide a cheap and simple part for mounting and removing accessories around and/or on a shaving head in a simple and quick manner, the auxiliary part according to the invention is characterized in that it is formed by an element (8) which at one side can be connected to the outer cutting member (4) and at its other side is provided with connecting means for one or more accessories (9, 14).

The invention relates to an auxiliary part for mounting attachments such as a skin stretcher, a lubricator, and the like on or around an outer cutting member of an electric shaver in a detachable manner.

Electric shavers provided with attachments such as a skin stretcher and a lubricator, which are provided around or against the shaving head, respectively, are known per se. An electric shaver provided with rotary cutting members is known from U.S. Pat. No. 2,246,459 with a skin stretcher member provided around the outer cutting member of the shaving head. Furthermore, European patent document EP 0 773 855 discloses a manual shaver provided with a lubricant strip provided thereon which applies a certain amount of lubricant to the skin during shaving, with the result that shaving is performed more smoothly.

Such attachments are subject to pollution and wear during use. The former will occur mainly with the skin stretcher member, especially in electric shavers which are used for dry as well as wet shaving. Although rinsing under a tap suffices for normal cleaning, a more thorough cleaning will be desirable from time to time, for which the skin stretcher member will have to be detached from the shaving head. The lubricant carrier will supply the lubricant in the course of its operation and will be exhausted after some time, whereupon replacement is necessary.

The invention has for its object to provide an auxiliary part which is of an inexpensive and simple construction and by means of which attachments can be provided on or around a shaving head in a simple and fast manner and can be removed therefrom again.

To achieve this object, the auxiliary part according to the invention is characterized in that it is formed by an element which can be clicked onto the corresponding outer cutting member by its one side and is provided at its other side with fastening means, for example snap connection means, for one or several attachments.

All attachments present can be mounted to the shaving head simultaneously by means of said element in this manner, and can be removed again, if so desired, also simultaneously. This leads to a considerably enhanced ease of use. The element may here be used on the shaving head of shavers of both the rotary and the oscillatory type.

In an embodiment of the auxiliary part suitable for a shaver whose outer cutting member is formed by a shaving foil, the auxiliary part has a rectangular shape with one or two rectangular recesses, each of which narrowly fits the outer circumference of the cutting member(s), and said auxiliary part is provided at its upper side along the long sides of the respective recesses with means for fastening at least one skin stretcher member and at least one lubricant carrier. The inner cutting member in such a shaver may then be formed by an oscillatory reciprocating shaving element or by a rotating cylindrical shaving element.

In a further embodiment suitable for a shaver with a rotary cutting member, the annular element is provided at its inner circumference with a cylindrical surface which narrowly fits around the outer circumference of the cutting member, and is also provided with a cylindrical surface at its outer circumference, over which surface an annular skin stretcher member or lubricant member is provided with narrow fit.

In a further embodiment, a surface with a raised, slightly conical edge is provided within the ring so as to be connected to the ring, on which edge a lubricant carrier can be provided.

For fastening the auxiliary part with the attachments provided thereon securely on the outer cutting member, the central surface is provided at its other side with a projection which fits an accommodation space of the cutting member. The auxiliary part in this manner is not only in contact with the outside of the cutting member, but also with the central cavity present in the cutting member.

To make it clear to a user of the electric shaver when the lubricant carrier is due for replacement, a wear indicator is provided below the lubricant carrier, which becomes visible when the lubricant carrier has become substantially exhausted and is due for replacement. This indicator may be a legend or a colored spot.

The invention further relates to an electric shaver whose shaving head is provided with an auxiliary part as described above.

The invention will be explained in more detail below with reference to the drawing in which an embodiment of an auxiliary part with attachments for an electric shaver is shown by way of example.

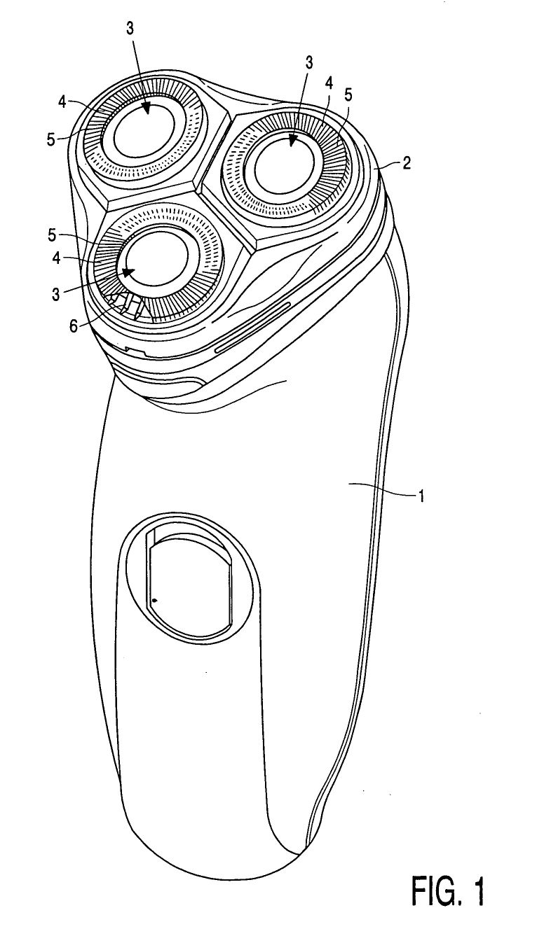

FIG. 1 diagrammatically and not true to scale shows an electric shaver with rotary cutting members in perspective view;

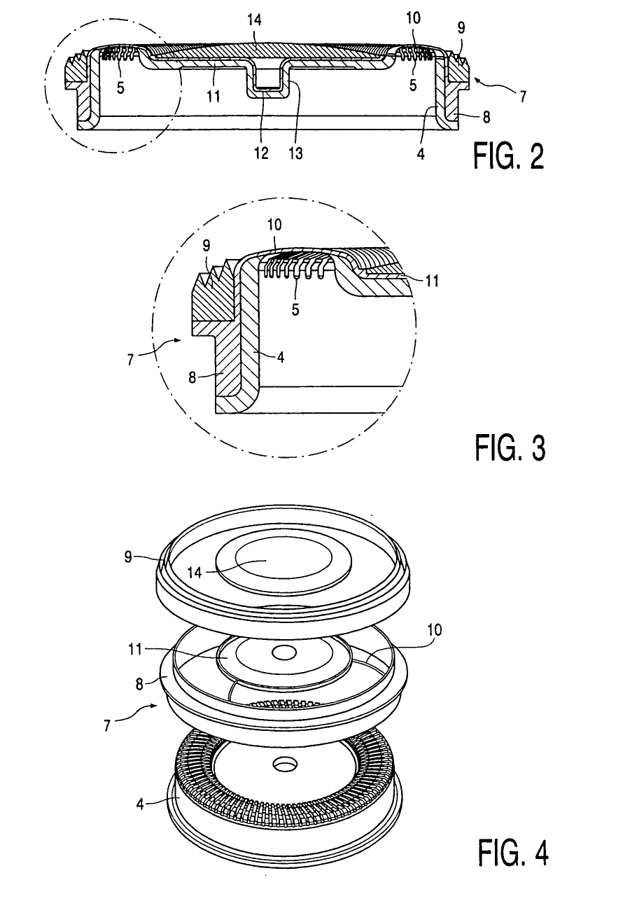

FIG. 2 shows the auxiliary part with attachments in a diagrammatic cross-sectional view not true to scale;

FIG. 3 shows part of the auxiliary part of FIG. 2 on an enlarged scale;

FIG. 4 shows a combination of an outer cutting member with auxiliary part and attachments in an exploded view;

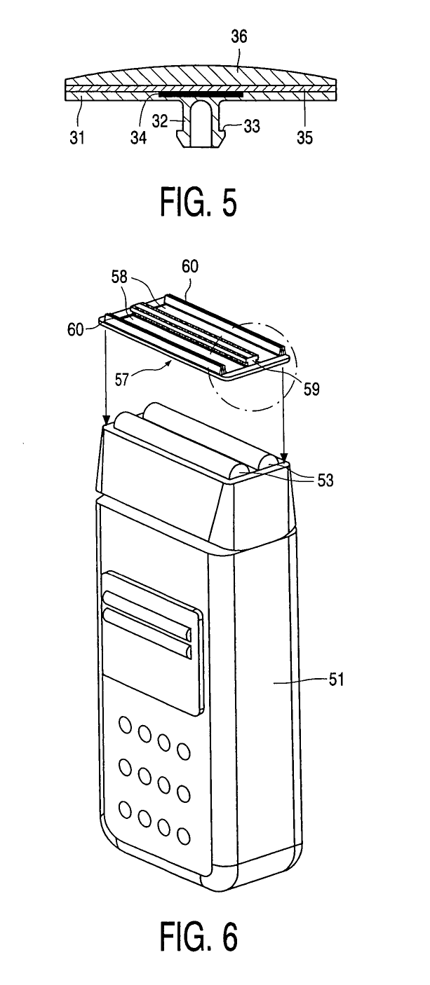

FIG. 5 shows an alternative embodiment of an auxiliary part according to the invention in a diagrammatic cross-sectional view;

FIG. 6 is a diagrammatic perspective view not true to scale of an electric shaver with a shaving foil and, shown above it, an auxiliary part which can be placed thereon; and

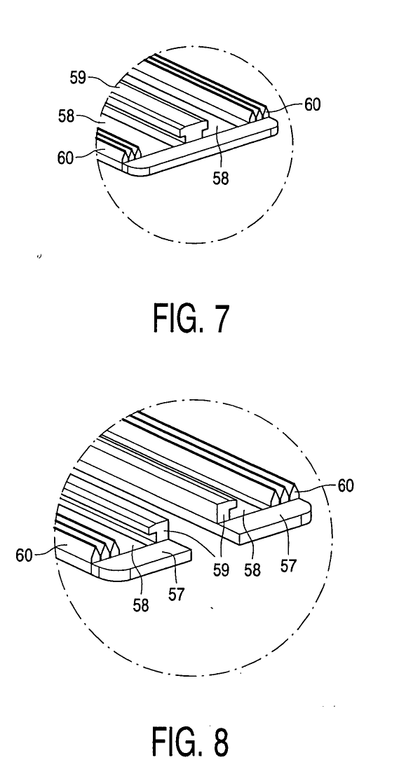

FIGS. 7 and 8 are enlargements of details of the auxiliary part which can be mounted in FIG. 6.

The electric shaver shown in FIG. 1 is provided with a housing 1 with a shaving head holder 2 which can be removed from the housing or which is hinged to the housing. Three shaving heads 3 are accommodated in the shaving head holder 2, each having an outer hair cutting member 4 with hair inlet openings 5 and an inner hair cutting member 6, which latter member is capable of being driven into rotation with respect to the outer cutting member. The inner hair cutting members are driven by a motor (not shown) which is accommodated in the housing of the shaver.

FIG. 2 shows a cross-section of an outer cutting member 4. An auxiliary part 7 with attachments is snapped home onto the outer cutting member 4. The auxiliary part 7 consists of an annular element 8 which has an inner diameter such that it narrowly fits around the cutting member 4. A skin stretcher member 9 is provided on the annular element 8. The annular element 8 is connected to a central surface 11 via a few connecting portions 10, which surface lies somewhat depressed in the central portion of the cutting member 4 and is provided with a projection 12 at its lower side, which projection is accommodated in a cavity 13 in the cutting member 4.

The annular element 8 is very securely fastened to the outer cutting member 4 in this manner. A disc 14 of a material comprising a lubricant is provided on the central surface 11. The attachments 9 and 14 are thus mounted to the outer cutting member 4 by means of a carrier element 8 and can be removed again from the cutting member 4 simultaneously with the annular carrier 8 when either the skin stretcher member 9 is polluted or the lubricant carrier 14 is exhausted.

To clarify the construction of the auxiliary part 7 and the manner in which it is provided on the cutting member 4, FIG. 3 shows a detail from FIG. 2 on an enlarged scale, while the parts are depicted in perspective view in FIG. 4.

To render it recognizable to the user that the lubricant carrier 14 has been almost used up, the central surface 11 below the lubricant disc 14 is provided with a legend or a colored spot which indicates that the lubricant disc is due for replacement. At that moment the lubricant disc may be removed from the cutting member together with the skin stretcher member by means of the annular element 8 and be replaced with a new disc.

FIG. 5 shows an auxiliary part in cross-section for fastening a lubricant carrier on an outer cutting member of a rotary shaver. Reference numeral 31 here denotes a base part which is provided at its one side with a projection 32 which is somewhat resilient owing to axial incisions (not shown) so that it can cooperate with a cavity in the outer cutting member. The edge 33 can then grip behind a mating rim (not shown) in the cavity so that a snap connection is created. A wear indicator 34 is provided on the base part 31, as well as a layer 35 by means of which a lubricant carrier 36 is fastened to the base part. A lubricant carrier for an electric shaver is obtained in this manner which is easy to mount and to exchange.

FIG. 6 diagrammatically and in perspective view shows an electric shaver with a housing 51 and outer cutting members 53 in the form of shaving foils. A frame 57, for example made of synthetic resin, is shown above the cutting members 53 and is provided with elongate recesses 58 with a shape which narrowly fits around the two cutting members 53. The frame is provided at its upper side along the longer sides of said recesses 58 with means (not shown) by which a lubricant carrier 59 and two skin stretcher members 60 can be mounted to the upper side of the frame 57.

FIG. 7 shows part of the frame 57 on an enlarged scale.

Although the frame 57 is depicted as an integral whole for the two cutting members 53 in the embodiment of FIGS. 6 and 7, it is alternatively possible to construct the frame 57 in two parts as shown in FIG. 8.

It should be noted that the frame 57 may be fastened on the housing 51 of the shaver, but it is alternatively possible to fasten the frame 57 of an adapted shape to the shaving foil 53 such that it forms as it were an intergral whole therewith.

1-20. (canceled)

21. An auxiliary part for mounting shaving attachments to an outer cutting member of an electric shaver in a detachable manner, wherein said outer cutting member has a multiplicity of hair inlet openings extending from an outer surface of the outer cutting member to an inner surface, and wherein the hair inlet openings are arranged such, during shaving, hairs to be shaved extend through respective openings, the auxiliary part being formed by an element having two opposite sides and configured to snap onto the corresponding outer cutting member by one of the two sides, said element being provided, at the other of the two sides, with means for removably fastening at least one shaving attachment to the element.

22. An auxiliary part as claimed in claim 21, arranged for snapping onto an electric shaver whose outer cutting member is formed by a shaving foil, the auxiliary part having a rectangular shape with at least one rectangular recess which narrowly fits the outer circumference of the cutting member(s), said auxiliary part being provided at its upper side along the long sides of the recess with said means for removably fastening at least one shaving attachment.

23. An auxiliary part as claimed in claim 21, arranged for snapping onto an electric shaver provided with rotary cutting members each having a respective outer circumference, said element including an annular element which has an inner circumference and an outer circumference, said annular element being provided at said inner circumference with an inner cylindrical surface which narrowly fits around the outer circumference of the cutting member, and being also provided with an outer cylindrical surface at said outer circumference, an annular shaving attachment being provided with narrow fit over said outer cylindrical surface.

24. An electric shaver with at least one shaving head comprising an outer cutting member, each shaving head being provided with an auxiliary part as claimed in claim 21 which can be snapped home on said shaving head and can be removed therefrom.

25. An electric shaver with at least one shaving head comprising an outer cutting member, each shaving head being provided with an auxiliary part as claimed in claim 21 which can be snapped home on said shaving head and can be removed therefrom, said auxiliary part being provided with at least one shaving attachment removably fastened thereto, the shaving attachment thereby being removable from the shaver by removing the shaving attachment.

26. An electric shaver as claimed in claim 25, said shaving attachment being a skin stretcher.

27. The auxiliary part of claim 21, said one of the two sides having a curved surface that facilitates the snapping onto said cutting member.

28. The auxiliary part of claim 21, wherein said element is configured to slidingly snap onto the cutting member.

29. A method for providing an auxiliary part for mounting shaving attachments to an outer cutting member of an electric shaver in a detachable manner, wherein said outer cutting member has a multiplicity of hair inlet openings extending from an outer surface of the outer cutting member to an inner surface, and wherein the hair inlet openings are arranged such, during shaving, hairs to be shaved extend through respective openings, said method comprising:
forming the auxiliary part by an element having two opposite sides and configured to snap onto the corresponding outer cutting member by one of the two sides; and
providing, at the other of the two sides, said element with means for removably fastening at least one shaving attachment to the element.
